(19) United States
(12) Patent Application Publication
(10) Pub. No.: US 2023/0094217 A1
(43) Pub. Date: Mar. 30, 2023

(54) SYSTEM AND METHOD FOR PROVIDING INFORMATION RELATING TO A VEHICLE AND/OR A DRIVER OF A VEHICLE TO AN OCCUPANT OF ANOTHER VEHICLE

(71) Applicant: Lear Corporation, Southfield, MI (US)

(72) Inventor: David GALLAGHER, Sterling Heights, MI (US)

(73) Assignee: Lear Corporation, Southfield, MI (US)

(21) Appl. No.: 17/448,786

(22) Filed: Sep. 24, 2021

(51) Int. Cl. B60W 50/14; B60W 50/10; H04W 4/46

(52) U.S. Cl. CPC B60W 50/14; B60W 50/10; H04W 4/46; B60W 2050/146

(57) ABSTRACT

A system for providing information relating to a remote vehicle and/or a driver of the remote vehicle to an occupant of a host vehicle. The system includes an interface configured to be mounted in the host vehicle, and a controller configured to be mounted in the host vehicle and provided in communication with the interface. The controller is configured to transmit via a communication module on-board the host vehicle a wireless request message to the remote vehicle, the request message including a request for information relating to the remote vehicle and/or the driver of the remote vehicle. The controller is configured to receive via the communication module a wireless response message including information relating to the remote vehicle and/or the driver of the remote vehicle. The controller is also configured to provide via the interface the information of the response message to the occupant of the host vehicle.

### TECHNICAL FIELD

The following relates to a system and method for providing information relating to a vehicle and/or a driver of a vehicle to an occupant of another vehicle, such as by utilizing vehicle-to-everything (V2X) communication technology.

### BACKGROUND

When a vehicle is stopped or pulled over by law enforcement officials, the safety of those involved in such a traffic stop, including private individuals and law enforcement officials, is a matter of great and increasing importance. In that regard, due to the direct interpersonal interaction required during a traffic stop, the private individual(s) and/or law enforcement official(s) involved may be at significant risk of injury or even death in the event of a physical altercation, an accident involving surrounding vehicular traffic, the airborne transmission of disease (e.g., COVID-19), or other factors or incidents.

While third-party applications (“apps”) exits for “smart” devices which may be useful in the event of or during a traffic stop, such as “Mobile Justice” offered by the American Civil Liberties Union (ACLU) or “Pulled Over” offered as part of the Siri virtual assistant from Apple, Inc., such third-party apps merely enable reporting and/or recording of traffic stop incidents. Consequently, such third-party apps either fail to or do not adequately address the problems associated with traffic stops described above.

Vehicle-to-everything or vehicle-to-x (V2X) communication is the passing of information from a vehicle to any entity that may affect the vehicle or its occupants, and vice versa. V2X is a vehicular communication that incorporates or includes other more specific types of communication such as Vehicle-to-Infrastructure (V2I), Vehicle-to-Network (V2N), Vehicle-to-Vehicle (V2V), Vehicle-to-Pedestrian (V2P), and Vehicle-to-Device (V2D). The main motivations for V2X communication are road safety, traffic efficiency, and energy savings, as well as vehicle occupant safety, information, and comfort.

One type of V2X communication technology is Dedicated Short Range Communication (DSRC) Wireless Local Area Network (WLAN) based. Another type of V2X communication technology is cellular based, which may also be referred to as Cellular Vehicle-to-everything (CV2X). V2X communication may use WLAN technology and work directly between vehicles, which form a vehicular ad-hoc network as two V2X transmitters come within each range of each other. Hence it does not necessarily require any infrastructure for vehicles to communicate, which is key to assure safety in remote or little developed areas.

A Vehicle equipped with V2X communication technology may transmit/receive messages containing vehicle data such as speed, heading, type, etc. These messages are created from the standards provided by the facility layer. The standard messages are Cooperative Awareness Messages (CAM) and Decentralized Environmental Notification Messages (DENM) per the European Telecommunications Standards Institute (ETSI) and Basic Safety Message (BSM) per the Society of Automotive Engineers (SAE) J2735 standard. The data volume of these messages is very low. The radio technology could be any of WLAN based IEEE 802.11p standards developed by the Institute of Electrical and Electronics Engineers (IEEE) or cellular based PC5 interface.

As a result, there exists a need for a system and method that would utilize communication technology, such as V2X communication technology, to enable, allow, or permit activities associated with traffic stops to be conducted without requiring or with reduced direct interaction between the private individual(s) and law enforcement official(s) involved. Such a system and method would enable, allow, or permit activities associated with a traffic stop to be conducted in a remote, virtual, or contactless fashion, thereby reducing risk and increasing safety for all. Such a system and method would thus increase, improve, and/or ensure safe interpersonal interactions between private individuals and law enforcement officials during a traffic stop, one of the most common situations giving rise to such interactions, and thereby address, mitigate, reduce, and/or eliminate the issues and/or problems associated with traffic stops as described herein.

### SUMMARY

According to one non-limiting exemplary embodiment described herein, a system for providing information relating to a remote vehicle and/or a driver of the remote vehicle to an occupant of a host vehicle is provided. The system comprises an interface configured to be mounted in the host vehicle, and a controller configured to be mounted in the host vehicle and provided in communication with the interface. The controller is configured to transmit via a communication module on-board the host vehicle a wireless request message to the remote vehicle, the request message comprising a request for information relating to the remote vehicle and/or the driver of the remote vehicle. The controller is configured to receive via the communication module a wireless response message comprising information relating to the remote vehicle and/or the driver of the remote vehicle, and the controller is configured to provide via the interface the information of the response message to the occupant of the host vehicle.

According to another non-limiting exemplary embodiment described herein, a system for providing information relating to a host vehicle and/or a driver of the host vehicle to an occupant of a remote vehicle is provided. The system comprises an interface for use on-board the host vehicle, and a controller for use on-board the host vehicle, the controller to be provided in communication with the interface. The controller is configured to receive via a communication module a wireless request message from the remote vehicle, the request message comprising a request for information relating to the host vehicle and/or the driver of the host vehicle. In response to a command received from the controller, the interface is configured to prompt the driver of the host vehicle for an authorization to provide information relating to the host vehicle and/or the driver of the host vehicle to the remote vehicle in response to the request message received from the remote vehicle. In response to receiving via the interface the authorization from the driver of the host vehicle, the controller is configured to transmit via the communication module a wireless response message comprising information relating to the host vehicle and/or the driver of the host vehicle.

According to another non-limiting exemplary embodiment described herein, a non-transitory computer readable storage medium is provided having stored computer executable instructions for providing information relating to a remote vehicle and/or a driver of the remote vehicle to an occupant of a host vehicle comprising an interface and a controller in communication with the interface. The computer executable instructions are configured to cause the controller to transmit via a communication module on-board the host vehicle a wireless request message to the remote vehicle, the request message comprising a request for information relating to the remote vehicle and/or the driver of the remote vehicle, receive via the communication module a wireless response message comprising information relating to the remote vehicle and/or the driver of the remote vehicle, and provide via the interface the information of the response message to the occupant of the host vehicle.

A detailed description of these and other non-limiting exemplary embodiments of a system and method for providing information relating to a vehicle and/or a driver of a vehicle to an occupant of another vehicle, such as by utilizing V2X communication technology, is set forth below together with the accompanying drawings.

### BRIEF DESCRIPTION OF THE DRAWINGS

FIG. 1 is an exemplary, simplified block diagram of a vehicle equipped for V2X communication for use with non-limiting exemplary embodiments of a system and method for providing information relating to a vehicle and/or a driver of a vehicle to an occupant of another vehicle according to the present disclosure;

FIG. 2 is an exemplary illustration of V2X communication for use in non-limiting exemplary embodiments of a system and method for providing information relating to a vehicle and/or a driver of a vehicle to an occupant of another vehicle according to the present disclosure;

FIG. 3 is an exemplary, simplified functional block diagram of an exemplary embodiment of a documentation request sequence from the law enforcement side utilizing V2X communication technology according to one non-limiting exemplary embodiment of a system and method for providing information relating to a vehicle and/or a driver of a vehicle to an occupant of another vehicle according to the present disclosure;

FIGS. 4A-4C are an exemplary, simplified block diagram of an exemplary embodiment of a documentation request sequence from the civilian side utilizing V2X communication technology according to one non-limiting exemplary embodiment of a system and method for providing information relating to a vehicle and/or a driver of a vehicle to an occupant of another vehicle according to the present disclosure;

FIG. 5 is an exemplary, simplified functional block diagram of an exemplary embodiment of a telecom request sequence from the law enforcement side utilizing V2X communication technology according to one non-limiting exemplary embodiment of a system and method for providing information relating to a vehicle and/or a driver of a vehicle to an occupant of another vehicle according to the present disclosure; and

FIGS. 6A-6C are an exemplary, simplified functional block diagram of an exemplary embodiment of a telecom request sequence from the civilian side utilizing V2X communication technology according to one non-limiting exemplary embodiment of a system and method for providing information relating to a vehicle and/or a driver of a vehicle to an occupant of another vehicle according to the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

With reference to Figures, a more detailed description of non-limiting exemplary embodiments of a system and method for providing information relating to a vehicle and/or a driver of a vehicle to an occupant of another vehicle, such as by utilizing V2X communication technology, will be provided. For ease of illustration and to facilitate understanding, like reference numerals may be used herein for like components and features throughout the drawings.

As previously described, when a vehicle is stopped or pulled over by law enforcement officials, the safety of those involved in such a traffic stop, including private individuals and law enforcement officials, is a matter of great and increasing importance. In that regard, due to the direct interpersonal interaction required during a traffic stop, the private individual(s) and/or law enforcement official(s) involved may be at significant risk of injury or even death in the event of a physical altercation, an accident involving surrounding vehicular traffic, the airborne transmission of disease (e.g., COVID-19), or other factors or incidents. While third-party applications (“apps”) exits for “smart” devices which may be useful in the event of or during a traffic stop, such as “Mobile Justice” offered by the American Civil Liberties Union (ACLU) or “Pulled Over” offered as part of the Siri virtual assistant from Apple, Inc., such third-party apps merely enable reporting and/or recording of traffic stop incidents. Consequently, such third-party apps either fail to or do not adequately address the problems associated with traffic stops described herein.

As also previously described, vehicle-to-everything (V2X) communication is the passing of information from a vehicle to any entity that may affect the vehicle, and vice versa. V2X is a vehicular communication that incorporates or includes other more specific types of communication such as Vehicle-to-Infrastructure (V2I), Vehicle-to-Network (V2N), Vehicle-to-Vehicle (V2V), Vehicle-to-Pedestrian (V2P), and Vehicle-to-Device (V2D). V2X communication is designed to improve road safety, traffic efficiency, and energy savings, as well as vehicle occupant safety, information, and comfort, and may be implemented using Dedicated Short Range Communication (DSRC) Wireless Local Area Network (WLAN) technology, or cellular technology, which may also be referred to as Cellular Vehicle-to-everything (CV2X). V2X communication may use WLAN technology and work directly between vehicles, which form a vehicular ad-hoc network as two V2X transmitters come within each range of each other. Hence it does not require any infrastructure for vehicles to communicate, which can improve safety in remote or little developed areas. A Vehicle equipped with V2X communication technology may transmit/receive messages containing vehicle data such as speed, heading, type, etc. These messages are created from the standards provided by the facility layer. The standard messages are Cooperative Awareness Messages (CAM) and Decentralized Environmental Notification Messages (DENM) per the European Telecommunications Standards Institute (ETSI) and Basic Safety Message (BSM) per the Society of Automotive Engineers (SAE) J2735 standard. The data volume of these messages is very low. The radio technology could be any of WLAN based IEEE 802.11p standards developed by the Institute of Electrical and Electronics Engineers (IEEE) or cellular based PC5 interface.

As a result, there exists a need for a system and method that would utilize communication technology, such as V2X communication technology, to enable, allow, or permit activities associated with traffic stops to be conducted without requiring or with reduced direct interaction between the private individual(s) and law enforcement official(s) involved. Such a system and method would enable, allow, or permit activities associated with a traffic stop to be conducted in a remote, virtual, or contactless fashion, thereby reducing risk and increasing safety for all. Such a system and method would thus increase, improve, and/or ensure safe interpersonal interactions between private individuals and law enforcement officials during a traffic stop, one of the most common situations giving rise to such interactions, and thereby address, mitigate, reduce, and/or eliminate the issues and/or problems associated with traffic stops as described herein.

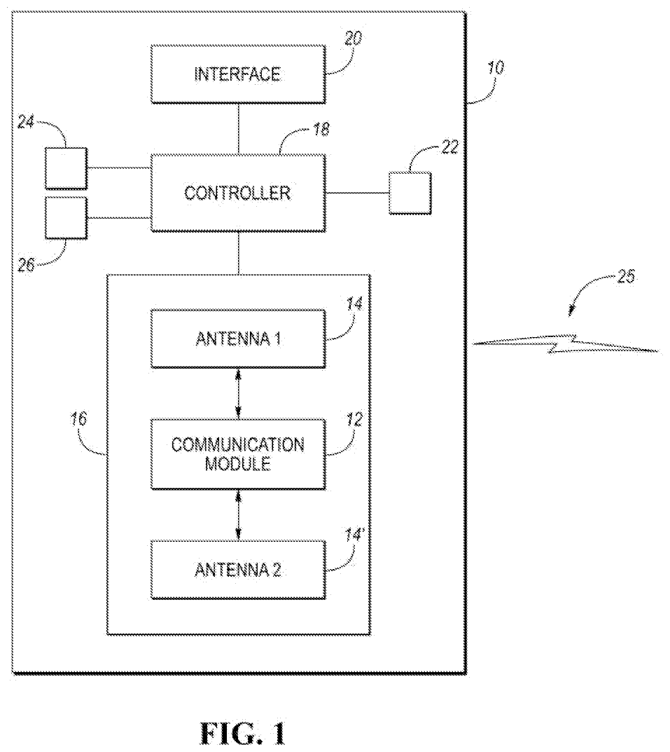

Referring now to FIG. 1, a simplified block diagram is shown of a vehicle 10 equipped for V2X communication for use with non-limiting exemplary embodiments of a system and method for providing information relating to a vehicle and/or a driver of a vehicle to an occupant of another vehicle according to the present disclosure according to the present disclosure. As seen therein, a vehicle 10 may comprise a communication unit or module 12 for providing V2X communication. The V2X communication module 12 may be provided in communication with a first antenna 14 (Antenna 1) for wireless DSRC V2X communication and a second antenna 14′ (Antenna 2) for wireless cellular V2X communication. Alternatively, both the first antenna 14 and the second antennas 14′ could be antennas for wireless DSRC V2X communication, or antennas for wireless cellular V2X communication, or a combination of both. Such communication between the communication unit 12 and the first and second antennas 14, 14′ may be provided over any suitable vehicle bus. The V2X communication module 12 and antennas 14, 14′ may be provided as part of an On-Board Unit (OBU) 16 for V2X communication.

The V2X communication module 12 of the vehicle 10 may be configured to enable and control wireless V2X communication between the vehicle 10 and other similarly equipped vehicles (i.e., V2V communication) or between the vehicle 10 and another node or device (e.g., Vehicle-to-Infrastructure (V2I) communication, Vehicle-to-Network (V2N) communication, Vehicle-to-Pedestrian (V2P) communication, or Vehicle-to-Device (V2D) communication). Such V2X communication may be accomplished utilizing radio frequency signals 25 for two-way transmission and/or reception of data according to known techniques, protocols, and/or standards associated with such communication. In that regard, the first and/or second antennas 14, 14′ of the vehicle 10 may be configured for transmitting and receiving DSRC WLAN or cellular radio frequency signals.

Still referring to FIG. 1, the vehicle 10 may further comprise a controller 18, which may be provided in and configured for communication with the OBU 16. The vehicle 10 may still further comprise an interface 20, which may be provided in and configured for communication with the controller 18. The controller 18 may include or may be provided in and configured for communication with a memory or storage medium or device 22. The controller 18 may further be provided in and configured for communication with audio and/or video systems 24, 26. The interface 20 may comprise any known type of input/output device for receiving input from and/or providing output to a user, driver, and/or occupant of the vehicle 10, such as a Human-Machine Interface (HMI) including a touch-screen device mounted or configured to be mounted in the vehicle 10, or a personal computer system configured for communication with the OBU 16 or controller 18.

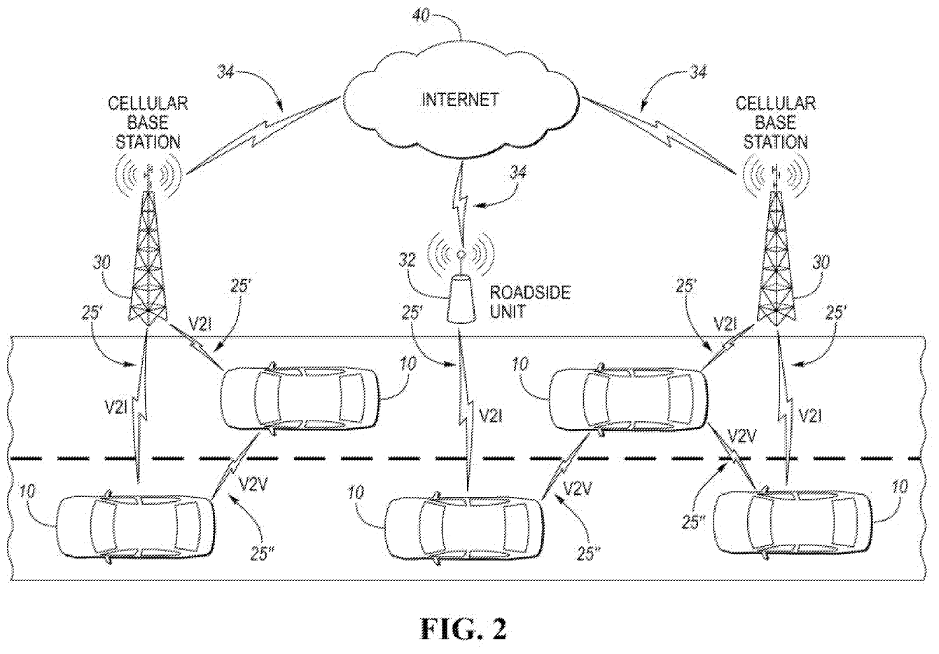

It is also noted that, alternatively, the controller 18, interface 20, memory or storage device 22, audio system 24, and/or video system 26 may individually, collectively, or in any combination, be part of a mobile device (e.g., a “smart” device or a personal computer) configured for communication with the OBU 16. Such communication between the OBU 16, controller 18, interface 20, memory or storage device 22, audio system 24, and/or video system 26 may once again be provided over any suitable vehicle bus or link, which may include a Controller Area Network (CAN) bus and/or any known type of wired or wireless bus or link such as Bluetooth, WiFi, or a Universal Serial Bus (USB). The configuration, operation, and/or functions of the OBU 16, controller 18, interface 20, AN unit(s) 24, 26 are further described herein in detail in connection with FIGS. 2, 3, 4A-4C, 5, and 6A-6C.

Referring next to FIG. 2, an illustration is shown of one example of V2X communication for use in non-limiting exemplary embodiments of a system and method for providing information relating to a vehicle and/or a driver of a vehicle to an occupant of another vehicle according to the present disclosure according to the present disclosure. As seen therein, and with continuing reference to FIG. 1, the V2X communication modules 12 of the vehicles 10 may be configured to enable and control wireless V2X communication utilizing radio frequency signals 25′ between the vehicle 10 and a node or device such as an infrastructure transmitter/receiver, which may be a cellular base station 30 or a roadside unit (RSU) 32 (e.g., Vehicle-to-Infrastructure (V2I) communication, Vehicle-to-Network (V2N) communication, or Vehicle-to-Device (V2D) communication). In that regard, the infrastructure transmitter/receiver, such as the cellular base station 30 and/or the roadside unit (RSU) 32 may also be configured for communication with each other over ad-hoc or established networks, such as the internet 40, which communication may be wireless communications 34, wired communications (not shown), or a combination of both.

Once again, such V2X communication may be accomplished utilizing radio frequency signals for transmission of data according to known techniques, protocols, and/or standards associated with such communication. The first and/or second antennas 14, 14′ of the vehicles 10 may be configured for transmitting and receiving DSRC WLAN or cellular radio frequency signals. As previously noted, the V2X communication modules 12 of the vehicles 10 may also be configured to enable and control wireless V2X communication between the vehicles 10 (i.e., V2V communication) utilizing radio frequency signals 25″.

As previously described, the wireless V2X communication 25 may comprise, for example, a Vehicle-to-Infrastructure (V2I) communication (e.g., 25′), a Vehicle-to-Vehicle (V2V) communication (e.g., 25″), a Vehicle-to-Pedestrian (V2P) communication, a Vehicle-to-Network (V2N) communication, or a Vehicle-to-Device (V2D) communication. As also previously described, the wireless V2X communication 25 may comprise a Dedicated Short Range Communication (DSRC) signal or a cellular communication signal. It should also be noted that, as used herein, the term wireless V2X communication refers to any type of wireless vehicle communication or signal to/from anything or to/from any type of destination/origin (e.g., infrastructure, vehicle, pedestrian, network, device, etc.) according to or implemented in any type of communication system.

As those skilled in the art will understand, the V2X communication modules 12, antennas 14, 14′, OBU 16, controller 18, interface 20, audio system 24, video system 26, as well as any other controller, control unit, communication unit, communication system, communication technology, system, subsystem, unit, module, interface, sensor, device, component, or the like described herein may individually, collectively, or in any combination comprise appropriate circuitry, such as one or more appropriately programmed processors (e.g., one or more microprocessors including central processing units (CPU)) and associated memory, storage media, or storage device(s), which may include stored operating system software and/or application software executable by the processor(s) for controlling operation thereof and for performing the particular algorithm or algorithms represented by the various functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC). The V2X communication modules 12, antennas 14, 14′, OBU 16, controller 18, interface 20, audio system 24, video system 26, as well as any other controller, control unit, communication unit, system, subsystem, unit, module, interface, sensor, device, component, or the like described herein, may therefore each comprise one or more processors and associated memory, storage media, or storage device having stored computer executable instructions for performing the particular algorithm or algorithms represented by the various methods, functions and/or operations described herein.

In one exemplary embodiment, the system and method of the present disclosure may comprise, provide, and/or utilize (i) V2X enabled modules and networks on a law enforcement vehicle, V2V if equipped; (ii) a documentation sharing network (state identification (ID), proof of vehicle insurance, vehicle registration, civil citation/infraction and/or warning, etc.); (iii) a commercial vehicle with V2X enabled modules and networks, V2V if equipped; (iv) in-cabin audio/microphone and/or video feeds or smart device application for both vehicles; (v) HMI interface controls and vehicle state/phone motion state monitoring; and (vi) cybersecurity for encrypting secure documentation.

In another exemplary embodiment, the system and method of the present disclosure may comprise, provide, and/or utilize (i) V2X/V2V module & network; (ii) documentation network and interne service/page for accessing/loading information and event transcripts; (iii) software for enabling communication of documentation between network and vehicles and between vehicles; (iv) HMI controls for granting requests and selecting information to share; (v) smart device application(s) for non-V2X/V2V operators; (vi) audio/camera feeds from vehicle and/or smart device with recording options; and (vii) citation connectivity service for transmitting digital civil citations/infractions and/or warning to be physically mailed.

The system and method of the present disclosure may comprise, provide, and/or utilize a combination of V2V & V2X communication technology to streamline the traffic law enforcement process while reducing safety risks to both the public and law enforcement officials. The system and method of the present disclosure rely on V2X and if available V2V enabled law enforcement vehicles in one embodiment to communicate with vehicles and occupants during traffic stops. Via the law enforcement vehicle HMI or onboard PC system, the system and method can request from vehicles within a given range that are engine-on but parked, digital documentation such as vehicle registration, proof of insurance, and/or digital state drivers licenses and such a request can be accepted or denied on the stopped vehicle HMI by the occupant or in non-V2V/V2X enabled vehicles may ping a smart device of an occupant that has an application installed which also contains this digital documentation or data.

According to the system and method of the present disclosure, in a vehicle equipped with audio/microphone and where applicable driver facing cameras, direct communication between vehicles can first occur, or occur solely, via such an audio/visual feed. Alternatively, in the case of smart device applications, a request to enable a downloaded application to perform the same function may be made. The system and method of the present disclosure may thus also allow, permit, or enable both parties to record the interaction. The system and method of the present disclosure may also include a means for vehicle owners, state Departments of Motor Vehicles (DMVs), and insurance companies to load such documents, data, or information securely onto the vehicle via V2X communication and securely encrypt that information along with a digital Vehicle Identification Number (VIN) so that sensitive data access can be limited even to vehicle occupants. In such a fashion, the V2X strategy of the system and method of the present disclosure may allow law enforcement officials or officers to gauge vehicle occupants without initial risk to either party, conduct entire traffic stops at a distance, and if applicable and enabled, publish citations and/or warning directly back into DMV databases via the telecommunication network for mailing to the occupant's listed address.

Prior to driving a vehicle, an occupant can enter or request of the granting body or authority that digital copies of documentation such as driver's licenses, vehicle registration, and/or proof of vehicle insurance be published to a specific digital VIN and transmitted via a V2X server network to the vehicle attached to that digital VIN. In the case of vehicles not equipped with V2V/V2X technology a smart device application may alternatively serve this purpose.

In the event of a traffic stop, once the stopped vehicle and the police vehicle are in park but still with at least battery power the law enforcement vehicle may send out a range limited (e.g., <50 yards) request to enabled vehicles or in range smart phones not in-motion to share any stored documentation. In enabled vehicles, that request may appear on the HMI for direct V2V communication. In smart device applications a push notification may occur to allow or accept the request to thereby share that documentation with the police vehicle in range. An option to select the driver if multiple IDs are stored would also be presented or to cancel/opt out.

In vehicles equipped with audio/microphone, the officer may also request a closed telecom conference with the vehicle to communicate with the occupants including to inform of reason for stop as well as to gage the occupant condition to help determine need and method for approach if required. In vehicles with cabin camera a request for video may also be made which could eliminate the need to approach the vehicle/occupant entirely and allow the officer to authenticate the driver to the digital ID. These requests again may be accepted or declined by the stopped vehicle occupant. A timeout sequence may also be employed for all requests so that the office/driver is made aware of the lack of connectivity or response and may proceed in a traditional manner. The system and method of the present disclosure may also offer both parties the opportunity to record the interaction and store it locally or upload it for storage on the cloud.

With smart devices, these same communication processes could occur with a 3rd party application that is capable of collecting documentation, allowing push communication, and audio/video feeds. In the event that a civil citation/infraction or warning is the result of the interaction, the ability to publish that citation back into the cloud for physical mailing to the associated address and identified person would also be enabled by connecting back into either the police system, local government, or a 3rd party service. In additions, the system and method provide, include, comprise, and/or utilize technology to clear stored vehicle and/or driver data (e.g., driver's license, vehicle registration, proof of vehicle insurance) to allow for vehicle transfer during sale or at vehicle scrap.

The V2X strategy of the system and method of the present disclosure would thus greatly reduce, if not eliminate, direct interaction between occupants, thereby increasing public safety. Private individuals and law enforcement officers may appreciate such technology, specifically its ability to reduce tensions between the public and law enforcement. The system and method of the present disclosure thus provide a secure interconnected system designed to ensure safe interaction for both parties. Accordingly, the system and method of the present application may be referred to as “Safe Authentication for Enforcement Technology”™ or “SAFE-T”™.

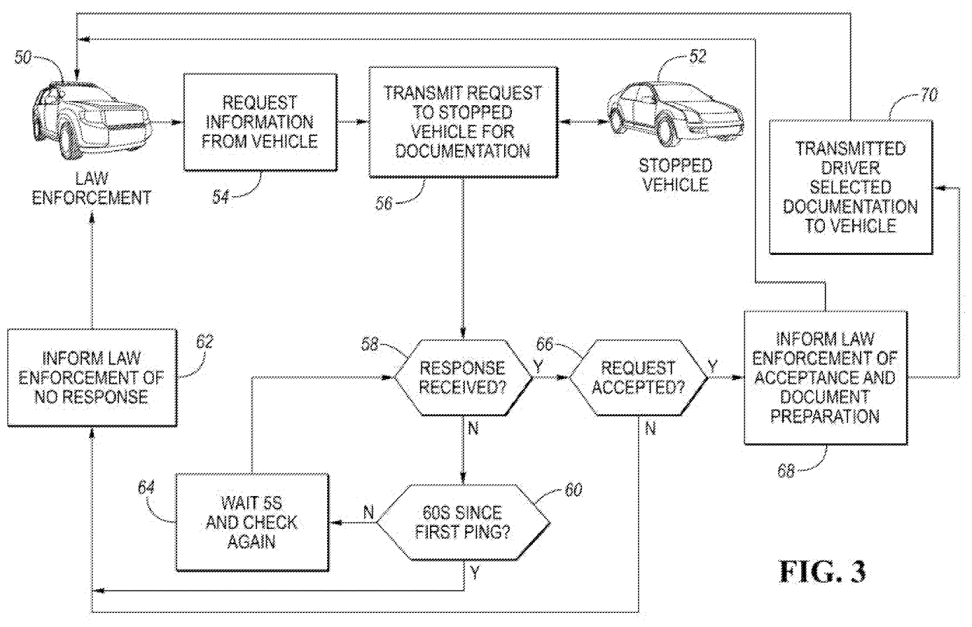

Referring now to FIG. 3, an exemplary, simplified functional block diagram of an exemplary embodiment of a documentation request sequence is shown from the law enforcement side utilizing V2X communication technology according to one non-limiting exemplary embodiment of a system and method for providing information relating to a vehicle and/or a driver of a vehicle to an occupant of another vehicle according to the present disclosure. As seen therein, and with continuing reference to FIGS. 1 and 2, a law enforcement officer or official operating a law enforcement vehicle 50 has stopped or pulled over a private vehicle 52. According to the system and method of the present disclosure, during such a traffic stop incident, the law enforcement official and/or vehicle 50 may request 54 information or documentation (e.g., driver's license, vehicle registration, proof of vehicle insurance) from the stopped vehicle 50 and such a request 54 may be transmitted 56 to the stopped vehicle 50 and its driver and/or occupants to provide that information or documentation. In that regard, it is noted that such a transmission 56 and any other messages transmitted and/or received between or by the law enforcement vehicle 50 and the stopped vehicle in the sequence illustrated in FIG. 3 may be accomplished via or using V2X communication technology and/or components as described herein. Such a request 54 may be manually effectuated by a law enforcement officer via the interface 20 of the law enforcement vehicle 50 or, alternatively, the request 54 and transmission 56 thereof may occur automatically after the law enforcement vehicle 50 and private vehicle 52 have stopped with each vehicle transmission in a “parked” condition. As previously noted, the transmission 56 of the request 54 may be range limited (e.g., <50 yards).

Thereafter, according to the system and method of the present disclosure, the controller 18 of the law enforcement vehicle 50 may determine 58 whether a response has been received from the stopped vehicle 52. If not, the controller 18 of the law enforcement vehicle 50 may determine 60 whether a configurable time period (e.g., 60 seconds) has transpired since the request 54 was first transmitted 56. If so, the law enforcement official may be informed 62 by the controller 18 of the law enforcement vehicle 50 via the interface 20 of the law enforcement vehicle 50 that no response has been received from the stopped vehicle 52. Alternatively, if the configurable time period has not expired, the controller 18 of the law enforcement vehicle 50 may wait 64 a second configurable time period (e.g., 5 seconds) before checking again whether a response has been received from the stopped vehicle 52.

If a response has been received from the stopped vehicle 52, then the controller 18 of the law enforcement vehicle 50 may determine 66 whether the request 54 transmitted at 56 has been accepted by the driver and/or occupant(s) of the stopped vehicle 52. If not, the law enforcement official may be informed 62 by the controller 18 of the law enforcement vehicle 50 via the interface 20 that no response has been received from the stopped vehicle 52. Alternatively, if the request 54 transmitted at 56 has been accepted by the driver and/or occupant(s) of the stopped vehicle 52, then the law enforcement official may be informed 68 by the controller 18 of the law enforcement vehicle 50 via the interface 20 of that acceptance and that preparation of the information and/or documentation requested is in-progress. Thereafter, that information and/or documentation selected by the driver and/or occupant(s) of the stopped vehicle 50 may be transmitted 70 to the law enforcement vehicle 52 for review by the law enforcement officer(s).

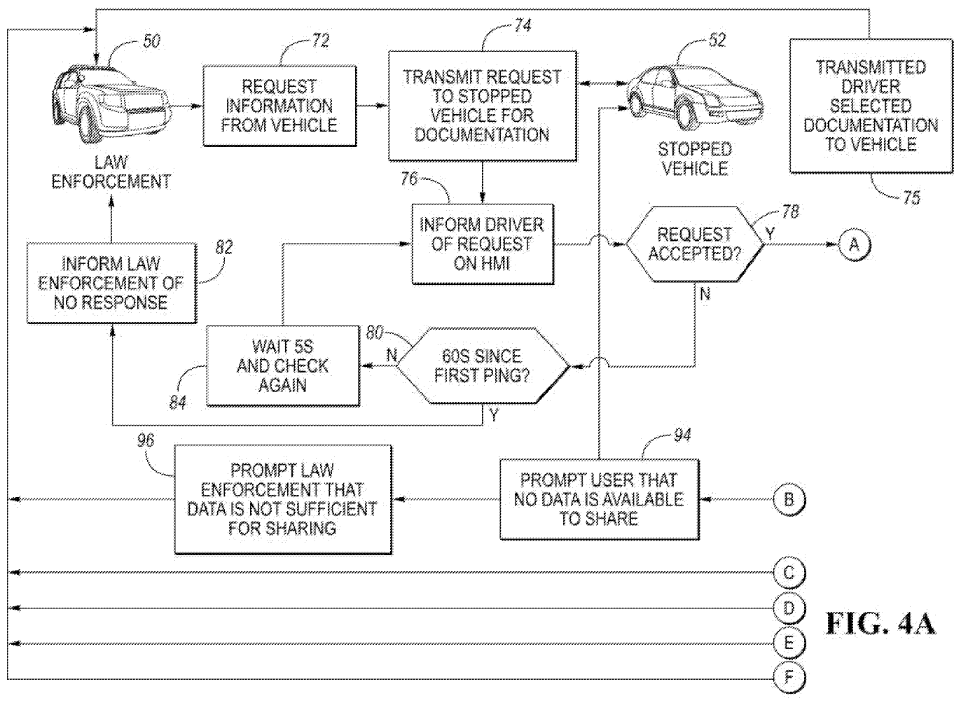

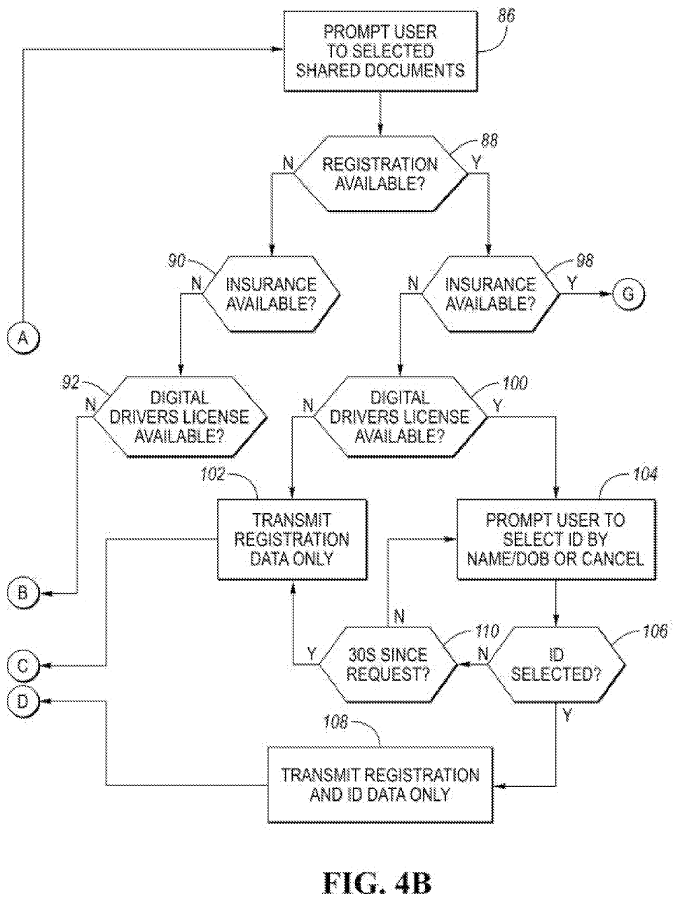

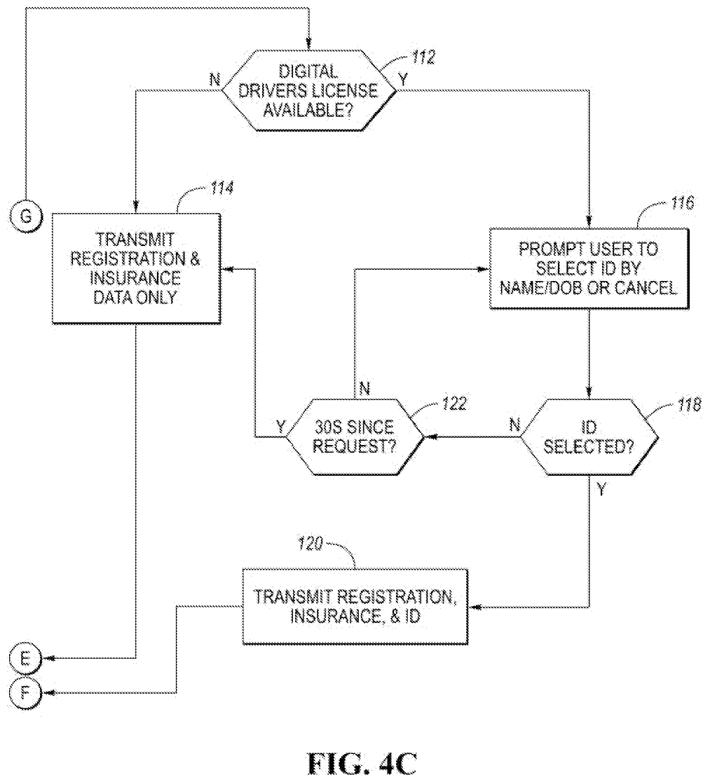

Referring now to FIGS. 4A-4C, an exemplary, simplified block diagram of an exemplary embodiment of a documentation request sequence is shown from the civilian side utilizing V2X communication technology according to one non-limiting exemplary embodiment of a system and method for providing information relating to a vehicle and/or a driver of a vehicle to an occupant of another vehicle according to the present disclosure. In that regard, it should be noted that the sequence illustrated may be implemented or accomplished with an HMI or “smart” device app as previously described herein. As seen in FIGS. 4A-4C, and with continuing reference to FIGS. 1-3, a law enforcement officer or official operating a law enforcement vehicle 50 has stopped or pulled over a private vehicle 52. According to the system and method of the present disclosure, during such a traffic stop incident, the law enforcement official and/or vehicle 50 may request 72 information or documentation (e.g., driver's license, vehicle registration, proof of vehicle insurance) from the stopped vehicle 50 and such a request 72 may be transmitted 74 to the stopped vehicle 50 and its driver and/or occupants to provide that information or documentation. In that regard, it is again noted that such a transmission 74 and any other messages transmitted and/or received between or by the law enforcement vehicle 50 and the stopped vehicle in the sequence illustrated in FIGS. 4A-4C may be accomplished via or using V2X communication technology and/or components as described herein. Such a request 72 may be manually effectuated by a law enforcement officer via the interface 20 of the law enforcement vehicle 50 or, alternatively, the request 72 and transmission 74 thereof may occur automatically after the law enforcement vehicle 50 and private vehicle 52 have stopped with each vehicle transmission in a “parked” condition. As previously noted, the transmission 74 of the request 72 may be range limited (e.g., <50 yards).

In response to such a request 72 and transmission 74 from the law enforcement vehicle 52, the stopped vehicle 52 may transmit 75 vehicle and/or driver information, documentation, or data selected by the user, occupant, or driver of the stopped vehicle 52 to the law enforcement vehicle 50 as set forth in greater detail herein. In that regard, according to the system and method of the present disclosure, the controller 18 of the stopped vehicle 52 may inform 76 the driver and/or occupant(s) of the stopped vehicle via the interface 20 of the stopped vehicle 52 of the request 72 for information or documentation received from the law enforcement vehicle 50. The controller 18 of the stopped vehicle 52 may then determine 78 whether that request 72 has been accepted by the driver and/or occupant(s) of the stopped vehicle. If not, the controller 18 of the stopped vehicle 52 may determine 80 whether a configurable time period (e.g., 60 seconds) has transpired since the request 72 was first transmitted 74. If so, the law enforcement official may be informed 82 by the controller 18 of the law enforcement vehicle 50 via the interface 20 of the law enforcement vehicle 50 that no response has been received from the stopped vehicle 52. Alternatively, if the configurable time period has not expired, the controller 18 of the stopped vehicle 50 may wait 84 a second configurable time period (e.g., 5 seconds) before again informing 76 the driver and/or occupant(s) of the stopped vehicle 52 via the interface 20 of the stopped vehicle 52 of the request 72 for information or documentation received from the law enforcement vehicle 50 and checking again whether that request 72 has been accepted 78 by the driver and/or occupant(s) of the stopped vehicle 52.

If the request 72 from the law enforcement vehicle 50 has been accepted by the driver and/or occupant(s) of the stopped vehicle 52, then the controller 18 of stopped vehicle 52 may prompt 86 the driver and/or occupant(s) of the stopped vehicle 52 via the interface of the stopped vehicle 52 to select that information or documentation to be shared with the law enforcement vehicle 50. If the controller 18 of the stopped vehicle determines that none of the vehicle registration, proof of vehicle insurance, and digital driver's license are available 88, 90, 92, then the controller 18 of the stopped vehicle 52 may inform 94 the driver and/or occupants of the stopped vehicle 52 via the interface 20 of the stopped vehicle 52 that no information, documentation, or data is available to share with the law enforcement vehicle 50. As well, the controller 18 of the stopped vehicle 52 may transmit a message to the law enforcement vehicle 52 in order to prompt 96 the law enforcement official via the controller 18 and the interface 20 of the law enforcement vehicle 50 that no information, documentation, or data is available from the stopped vehicle 52 or is insufficient to be shared.

Referring still to FIGS. 4A-4C, if the vehicle registration of the stopped vehicle 52 is available, then the controller 18 of the stopped vehicle 52 determines 98 whether the proof of insurance for the stopped vehicle 52 is available. If not, the controller 18 of the stopped vehicle determines 100 whether one or more digital driver's licenses associated with the stopped vehicle 52 is available. If not, then the controller of the stopped vehicle 52 transmits 102 only the available vehicle registration of the stopped vehicle 52 to the law enforcement vehicle 50. Otherwise, if one or more digital driver's license associated with the stopped vehicle 52 is available, then the controller 18 of the stopped vehicle 52 prompts 104 a user or occupant of the stopped vehicle 52 via the interface 20 of the stopped vehicle 52 to select via the interface 20 of the stopped vehicle 52 a digital driver's license (i.e., ID) to be shared by name and date-of-birth for that driver's license. The controller 18 of the stopped vehicle then determines 106 whether a digital driver's license has been selected by a user or occupant of the stopped vehicle 52. If so, then the controller 18 of the stopped vehicle 52 transmits 108 the available vehicle registration and the selected driver's license to the law enforcement vehicle 50.

Alternatively, if a digital driver's license has not been selected by a user or occupant of the stopped vehicle 52, the controller 18 of the stopped vehicle 52 determines 110 whether a configurable time period (e.g., 30 seconds) has transpired since the request 72 for information was first transmitted 74 by the law enforcement vehicle 50 to the stopped vehicle 52. If the configurable time period has not yet expired, the controller 18 of the stopped vehicle 52 again prompts 104 a user or occupant of the stopped vehicle 52 via the interface 20 of the stopped vehicle 52 to select a digital driver's license (i.e., ID) to be shared by name and date-of-birth for that driver's license. Otherwise, if the configurable time period has expired, the controller 18 of the stopped vehicle 52 transmits 102 only the available vehicle registration of the stopped vehicle 52 to the law enforcement vehicle 50.

If the controller 18 of the stopped vehicle determines 88 that the vehicle registration of the stopped vehicle 52 is available and determines 98 that the proof of insurance for the stopped vehicle 52 is available, then the controller 18 of the stopped vehicle determines 112 whether one or more digital driver's licenses associated with the stopped vehicle 52 is available. If not, then the controller 18 of the stopped vehicle 52 transmits 114 only the available vehicle registration and proof of insurance of the stopped vehicle 52 to the law enforcement vehicle 50. Otherwise, if one or more digital driver's license associated with the stopped vehicle 52 is available, then the controller 18 of the stopped vehicle 52 prompts 116 a user or occupant of the stopped vehicle 52 via the interface 20 of the stopped vehicle 52 to select via the interface 20 of the stopped vehicle 52 a digital driver's license (i.e., ID) to be shared by name and date-of-birth for that driver's license. The controller 18 of the stopped vehicle 52 then determines 118 whether a digital driver's license has been selected by a user or occupant of the stopped vehicle 52. If so, then the controller 18 of the stopped vehicle 52 transmits 120 the available vehicle registration and proof of insurance for the stopped vehicle 52 as well as the selected driver's license to the law enforcement vehicle 50.

Alternatively, if a digital driver's license has not been selected by a user or occupant of the stopped vehicle 52, the controller 18 of the stopped vehicle 52 determines 122 whether a configurable time period (e.g., 30 seconds) has transpired since the request 72 for information was first transmitted 74 by the law enforcement vehicle 50 to the stopped vehicle 52. If the configurable time period has not yet expired, the controller 18 of the stopped vehicle 52 again prompts 116 a user or occupant of the stopped vehicle 52 via the interface 20 of the stopped vehicle 52 to select a digital driver's license (i.e., ID) to be shared by name and date-of-birth for that driver's license. Otherwise, if the configurable time period has expired, the controller 18 of the stopped vehicle 52 transmits 114 only the available vehicle registration and proof of insurance of the stopped vehicle 52 to the law enforcement vehicle 50.

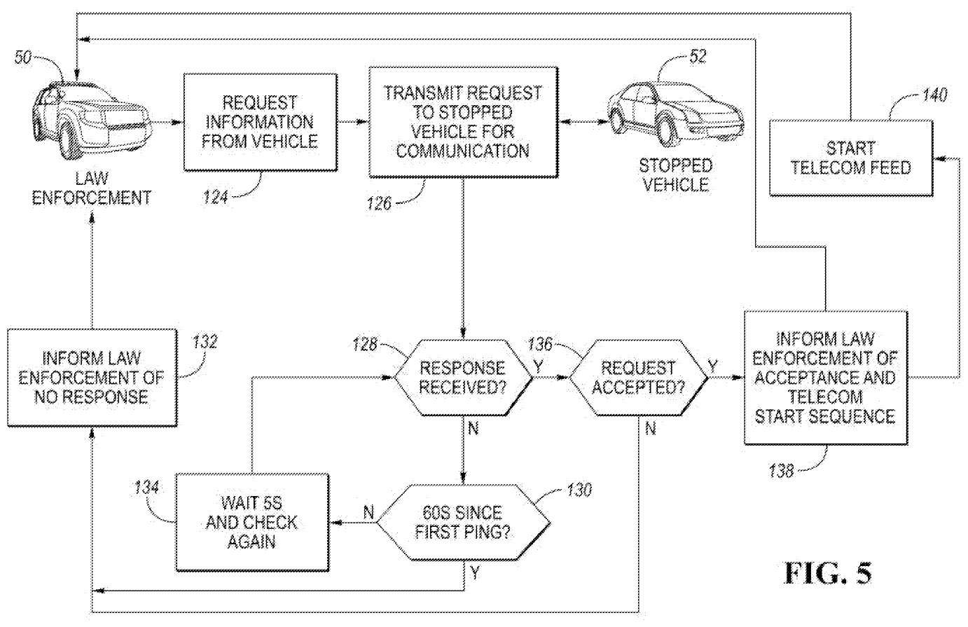

Referring next to FIG. 5, an exemplary, simplified functional block diagram of an exemplary embodiment of a telecom request sequence is shown from the law enforcement side utilizing V2X communication technology according to one non-limiting exemplary embodiment of a system and method for providing information relating to a vehicle and/or a driver of a vehicle to an occupant of another vehicle according to the present disclosure. As seen therein, and with continuing reference to FIGS. 1-3 and 4A-4C, a law enforcement officer or official operating a law enforcement vehicle 50 has stopped or pulled over a private vehicle 52. According to the system and method of the present disclosure, during such a traffic stop incident, the law enforcement official and/or vehicle 50 may request 124 information or documentation (e.g., driver's license, vehicle registration, proof of vehicle insurance) from the stopped vehicle 50 and such a request 124 may be transmitted 126 to the stopped vehicle 50 and its driver and/or occupants to provide that information or documentation. In that regard, it is noted that such a transmission 126 and any other messages transmitted and/or received between or by the law enforcement vehicle 50 and the stopped vehicle in the sequence illustrated in FIG. 5 may be accomplished via or using V2X communication technology and/or components as described herein. Such a request 124 may be manually effectuated by a law enforcement officer via the interface 20 of the law enforcement vehicle 50 or, alternatively, the request 124 and transmission 126 thereof may occur automatically after the law enforcement vehicle 50 and private vehicle 52 have stopped with each vehicle transmission in a “parked” condition. As previously noted, the transmission 126 of the request 124 may be range limited (e.g., <50 yards).

Thereafter, according to the system and method of the present disclosure, the controller 18 of the law enforcement vehicle 50 may determine 128 whether a response has been received from the stopped vehicle 52. If not, the controller 18 of the law enforcement vehicle 50 may determine 130 whether a configurable time period (e.g., 60 seconds) has transpired since the request 124 was first transmitted 126. If so, the law enforcement official may be informed 132 by the controller 18 of the law enforcement vehicle 50 via the interface 20 of the law enforcement vehicle 50 that no response has been received from the stopped vehicle 52. Alternatively, if the configurable time period has not expired, the controller 18 of the law enforcement vehicle 50 may wait 134 a second configurable time period (e.g., 5 seconds) before checking again whether a response has been received from the stopped vehicle 52.

If a response has been received from the stopped vehicle 52, then the controller 18 of the law enforcement vehicle 50 may determine 136 whether the request 124 transmitted at 126 has been accepted by the driver and/or occupant(s) of the stopped vehicle 52. If not, the law enforcement official may be informed 132 by the controller 18 of the law enforcement vehicle 50 via the interface 20 that no response has been received from the stopped vehicle 52. Alternatively, if the request 124 transmitted at 126 has been accepted by the driver and/or occupant(s) of the stopped vehicle 52, then the law enforcement official may be informed 138 by the controller 18 of the law enforcement vehicle 50 via the interface 20 of that acceptance and the controller 18 of the law enforcement vehicle 50 may start 140 a telecom feed to provide for or enable audio and/or video communication between the law enforcement officer and the driver and/or occupants of the stopped vehicle 52.

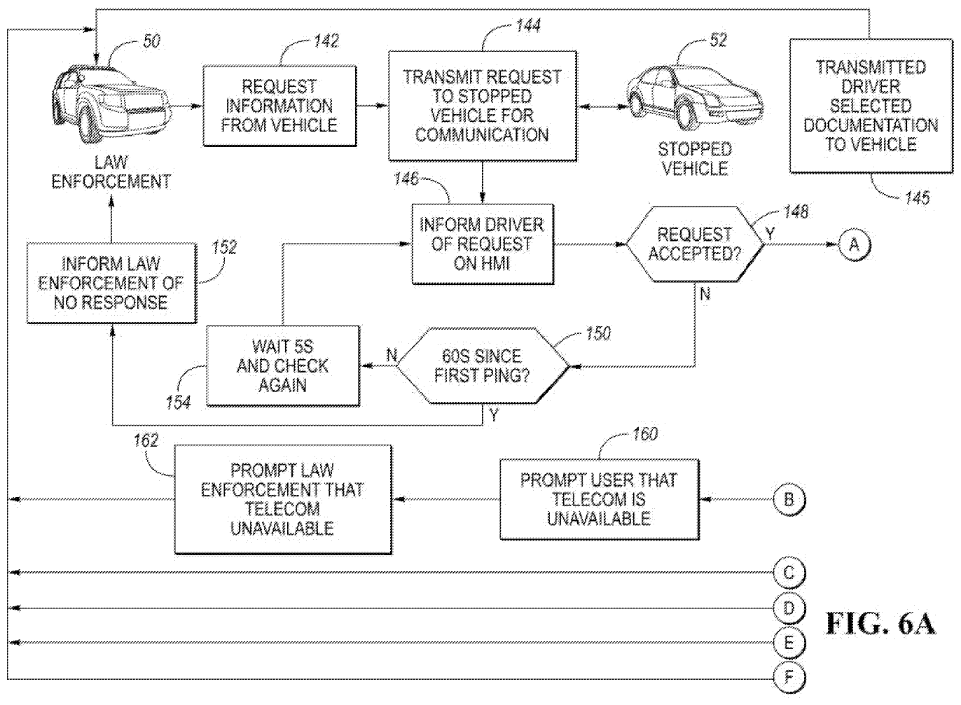

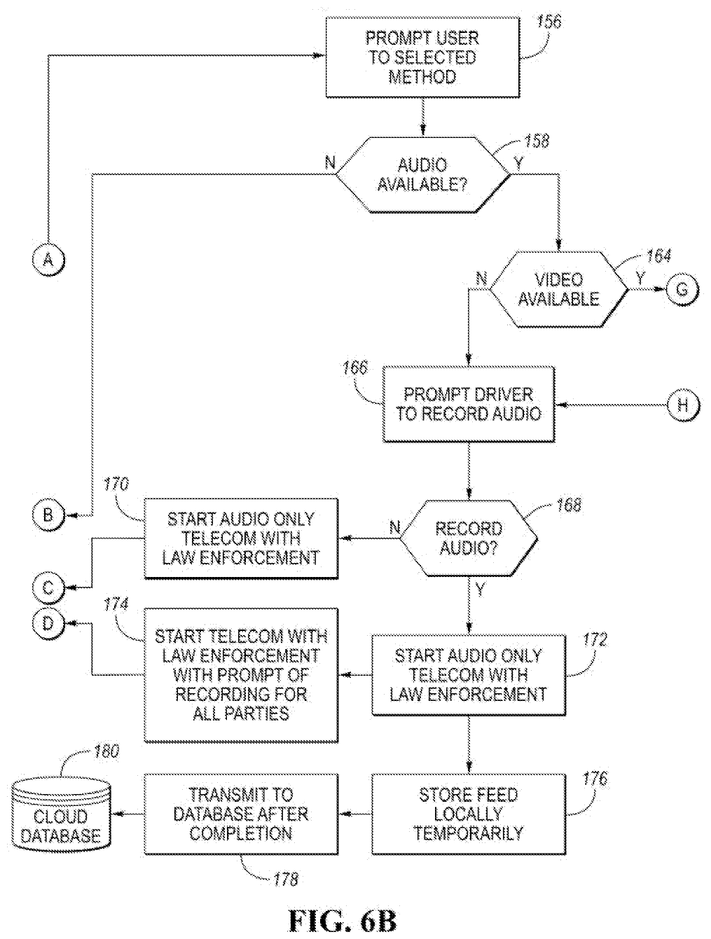

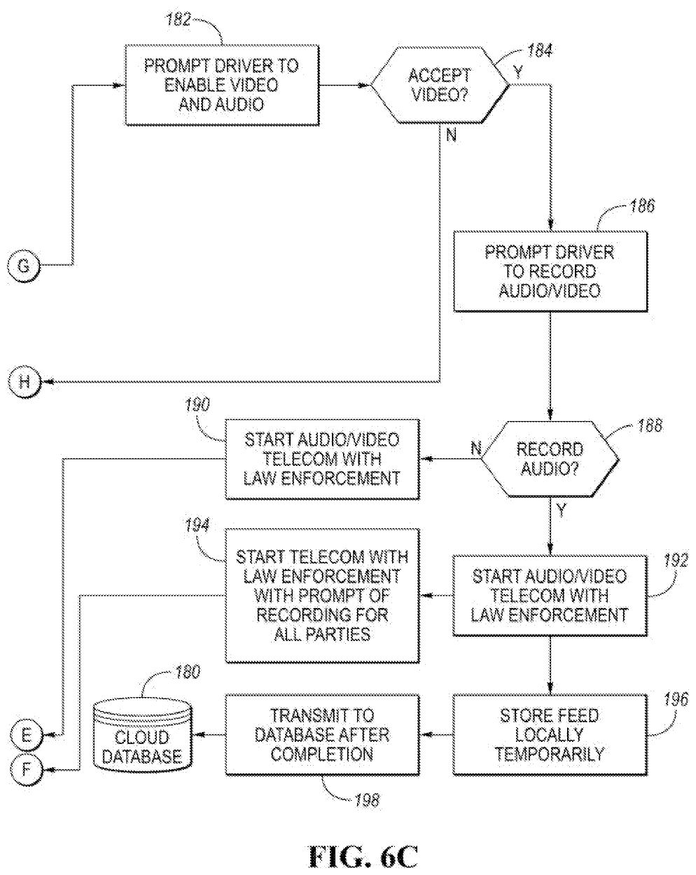

Now referring to FIGS. 6A-6C, an exemplary, simplified functional block diagram of an exemplary embodiment of a telecom request sequence is shown from the civilian side utilizing V2X communication technology according to one non-limiting exemplary embodiment of a system and method for providing information relating to a vehicle and/or a driver of a vehicle to an occupant of another vehicle according to the present disclosure. In that regard, it should be noted that the sequence illustrated may be implemented or accomplished with an HMI or “smart” device app as previously described herein. As seen in FIGS. 6A-6C, and with continuing reference to FIGS. 1-5, a law enforcement officer or official operating a law enforcement vehicle 50 has stopped or pulled over a private vehicle 52. According to the system and method of the present disclosure, during such a traffic stop incident, the law enforcement official and/or vehicle 50 may request 142 information or documentation (e.g., driver's license, vehicle registration, proof of vehicle insurance) from the stopped vehicle 50 and such a request 142 may be transmitted 144 to the stopped vehicle 50 and its driver and/or occupants to provide that information or documentation. In that regard, it is again noted that such a transmission 144 and any other messages transmitted and/or received between or by the law enforcement vehicle 50 and the stopped vehicle in the sequence illustrated in FIGS. 6A-6C may be accomplished via or using V2X communication technology and/or components as described herein. Such a request 142 may be manually effectuated by a law enforcement officer via the interface 20 of the law enforcement vehicle 50 or, alternatively, the request 142 and transmission 144 thereof may occur automatically after the law enforcement vehicle 50 and private vehicle 52 have stopped with each vehicle transmission in a “parked” condition. As previously noted, the transmission 144 of the request 142 may be range limited (e.g., <50 yards).

In response to such a request 142 and transmission 144 from the law enforcement vehicle 52, the stopped vehicle 52 may transmit 145 vehicle and/or driver information, documentation, or data selected by the user, occupant, or driver of the stopped vehicle 52 to the law enforcement vehicle 50 as set forth in greater detail herein. In that regard, according to the system and method of the present disclosure, the controller 18 of the stopped vehicle 52 may inform 146 the driver and/or occupant(s) of the stopped vehicle via the interface 20 of the stopped vehicle 52 of the request 142 for information or documentation received from the law enforcement vehicle 50. The controller 18 of the stopped vehicle 52 may then determine 148 whether that request 142 has been accepted by the driver and/or occupant(s) of the stopped vehicle. If not, the controller 18 of the stopped vehicle 52 may determine 150 whether a configurable time period (e.g., 60 seconds) has transpired since the request 142 was first transmitted 144. If so, the law enforcement official may be informed 152 by the controller 18 of the law enforcement vehicle 50 via the interface 20 of the law enforcement vehicle 50 that no response has been received from the stopped vehicle 52. Alternatively, if the configurable time period has not expired, the controller 18 of the stopped vehicle 50 may wait 154 a second configurable time period (e.g., 5 seconds) before again informing 146 the driver and/or occupant(s) of the stopped vehicle 52 via the interface 20 of the stopped vehicle 52 of the request 142 for information or documentation received from the law enforcement vehicle 50 and checking again whether that request 142 has been accepted 148 by the driver and/or occupant(s) of the stopped vehicle 52.

If the request 142 from the law enforcement vehicle 50 has been accepted by the driver and/or occupant(s) of the stopped vehicle 52, then the controller 18 of stopped vehicle 52 may prompt 156 the driver and/or occupant(s) of the stopped vehicle 52 via the interface of the stopped vehicle 52 to select a telecommunication method for communication between the stopped vehicle 52 and the law enforcement vehicle 50. In that regard, the controller 18 of the stopped vehicle may first determine 158 whether audio is available for such communication. If not, the controller 18 of the stopped vehicle 52 may prompt 160 the driver and/or occupant(s) of the stopped vehicle 52 that telecommunication between the stopped vehicle 52 and the law enforcement vehicle 50 is unavailable. In that event, the controller 18 of the stopped vehicle 52 may also transmit a message to the law enforcement vehicle 52 in order to prompt 162 the law enforcement official via the controller 18 and the interface 20 of the law enforcement vehicle 50 that telecommunication between the stopped vehicle 52 and the law enforcement vehicle 50 is unavailable.

Alternatively, if audio is available for such telecommunication between the stopped vehicle 52 and the law enforcement vehicle 50, the controller 18 of the stopped vehicle 52 may then determine 164 whether video is also available for such communication. If not, the controller 18 of the stopped vehicle 52 may prompt 166 the driver and/or occupant(s) of the stopped vehicle 52 to record the audio communications between the stopped vehicle 52 and the law enforcement vehicle 50 and determine 168 whether the driver and/or occupant(s) of the stopped vehicle 52 has chosen to record such audio communications. If not, then the controller 18 of the stopped vehicle may start 170 an audio only telecommunication link with the law enforcement vehicle 50. Alternatively, if the driver and/or occupant(s) of the stopped vehicle 52 has chosen to record such audio communications, the controller 18 of the stopped vehicle may start 172 an audio only telecommunication link with the law enforcement vehicle 50 and start 174 audio communications between the stopped vehicle 52 and the law enforcement vehicle 50 with a prompt for all parties that the audio communications are being recorded. The controller 18 of the stopped vehicle 52 may also temporarily store 176 such an audio feed locally (e.g., in a storage device on-board the stopped vehicle 52 or in a mobile device in the stopped vehicle 52) and, after completion of the audio communications, may transmit 178 that stored audio feed to a remote database 180, which may be cloud based.

If the controller 18 of the stopped vehicle 52 determines that both audio and video are available 158, 164 for telecommunication between the stopped vehicle 52 and the law enforcement vehicle 50, the controller 18 of the stopped vehicle 52 may then prompt 182 the driver and/or occupant(s) of the stopped vehicle 52 to enable both audio and video communications between the stopped vehicle 52 and the law enforcement vehicle 50. The controller 18 of the stopped vehicle 52 may also determine 184 whether the driver and/or occupant(s) of the stopped vehicle 52 has accepted such video communications. If not, the controller 18 of the stopped vehicle 52 may prompt 166 the driver and/or occupant(s) of the stopped vehicle 52 to record the audio communications between the stopped vehicle 52 and the law enforcement vehicle 50 and determine 168 whether the driver and/or occupant(s) of the stopped vehicle 52 has chosen to record such audio communications. From there, the sequence proceeds as previously described in action 170 or actions 172-178 (including audio feed storage to remote database 180).

Alternatively, if both audio and video are available 158, 164 for telecommunication between the stopped vehicle 52 and the law enforcement vehicle 50, and the controller 18 of the stopped vehicle 52 determines 184 that the driver and/or occupant(s) of the stopped vehicle 52 has accepted video for such communications, then the controller 18 of the stopped vehicle 52 may prompt 186 the driver and/or occupant(s) of the stopped vehicle 52 to record the audio and video communications between the stopped vehicle 52 and the law enforcement vehicle 50. The controller 18 of the stopped vehicle may also determine 188 whether the driver and/or occupant(s) of the stopped vehicle 52 has chosen to record such audio and video communications. If not, then the controller 18 of the stopped vehicle may start 190 an audio/video telecommunication link with the law enforcement vehicle 50. Alternatively, if the driver and/or occupant(s) of the stopped vehicle 52 has chosen to record such audio and video communications, the controller 18 of the stopped vehicle may start 192 an audio/video telecommunication link with the law enforcement vehicle 50 and start 194 audio/video communications between the stopped vehicle 52 and the law enforcement vehicle 50 with a prompt for all parties that the audio/video communications are being recorded. The controller 18 of the stopped vehicle 52 may also temporarily store 196 such an audio/video feed locally (e.g., in a storage device on-board the stopped vehicle 52 or in a mobile device in the stopped vehicle 52) and, after completion of the audio/video communications, may transmit 198 that stored audio feed to a remote database 180, which may be cloud based.

Thus, referring now to FIGS. 1-3, 4A-4C, 5, and 6A-6C, the present disclosure describes a system and method for providing information relating to a remote vehicle (e.g., stopped vehicle 52) and/or a driver of the remote vehicle to an occupant of a host vehicle (e.g., law enforcement vehicle 50). The system may comprise an interface 20 configured to be mounted in the host vehicle, and a controller 18 configured to be mounted in the host vehicle and provided in communication with the interface. The controller 18 may be configured to transmit via a vehicle-to-x (V2X) communication module (e.g., OBU 16 and/or module 12) on-board the host vehicle a request message to the remote vehicle, the request message comprising a request for information relating to the remote vehicle and/or the driver of the remote vehicle. The controller 18 may be configured to receive via the V2X communication module a response message comprising information relating to the remote vehicle and/or the driver of the remote vehicle, and the controller may be configured to provide via the interface 20 the information of the response message to the occupant of the host vehicle. It is noted, however, that any other type of wireless communication technology (including any other type of wireless communication modules, wireless transmissions, signals, or messages) may be utilized in the system and method of the present disclosure rather than vehicle-to-x (V2X) communication technology.

In that regard, the host vehicle may be a law enforcement vehicle and the occupant of the host vehicle may be a law enforcement officer. The controller 18 may be configured to transmit the request message via the V2X communication module in response to a command received via the interface 20 from the occupant, and the information of the request message or the response message may comprise registration information relating to the remote vehicle, insurance information relating to the remote vehicle, and/or driver's license information relating to the driver of the remote vehicle. The interface 20 may comprise a human machine interface or a personal computer system, and each of the request message and the response message may comprise a vehicle-to-vehicle (V2V) message.

The system may further comprise an audio system 24 and/or a video system 26 to provide telecommunication between the occupant of the host vehicle and the driver of the remote vehicle. Moreover, the information of the response message may be retrieved by the controller 18 from a storage device 22 on-board the remote vehicle. The controller may also be configured to transmit via the V2X communication module an information message to the remote vehicle and/or a remote database, the information message comprising information relating to a civil infraction or a civil citation associated with the remote vehicle and/or the driver of the remote vehicle

Still referring now to FIGS. 1-3, 4A-4C, 5, and 6A-6C, the present disclosure also describes a system and method for providing information relating to a host vehicle (e.g., stopped vehicle 52) and/or a driver of the host vehicle to an occupant of a remote vehicle (e.g., law enforcement vehicle 50). The system may comprise an interface 20 for use on-board the host vehicle, and a controller 20 for use on-board the host vehicle, the controller 18 to be provided in communication with the interface 20. The controller 18 may be configured to receive via a vehicle-to-x (V2X) communication module (e.g., OBU 16 and/or module 12) a request message from the remote vehicle, the request message comprising a request for information relating to the host vehicle and/or the driver of the host vehicle. In response to a command received from the controller 18, the interface 20 may be configured to prompt the driver of the host vehicle for an authorization to provide information relating to the host vehicle and/or the driver of the host vehicle to the remote vehicle in response to the request message received from the remote vehicle. In response to receiving via the interface 20 the authorization from the driver of the host vehicle, the controller 18 may be configured to transmit via the V2X communication module a response message comprising information relating to the host vehicle and/or the driver of the host vehicle. Once again, it is noted that any other type of wireless communication technology (including any other type of wireless communication modules, wireless transmissions, signals, or messages) may be utilized in the system and method of the present disclosure rather than vehicle-to-x (V2X) communication technology.

In that regard, the remote vehicle may be a law enforcement vehicle and the occupant of the remote vehicle may be a law enforcement officer. The information of the request message or the response message may comprise registration information relating to the host vehicle, insurance information relating to the host vehicle, and/or driver's license information relating to the driver of the host vehicle. The interface and controller may be part of a mobile device, or the interface may comprise a human machine interface configured to be mounted in the host vehicle and the controller may be configured to be mounted in the host vehicle. Each of the request message and the response message may comprise a vehicle-to-vehicle (V2V) message.

The system may further comprise an audio system 24 and/or a video system 26 to provide telecommunication between the driver of the host vehicle and the occupant of the remote vehicle. Moreover, the information of the response message may be retrieved from a storage device 22 on-board the host vehicle. The controller 18 may also be configured to receive via the V2X communication module an information message from the remote vehicle, the information message comprising information relating to a civil infraction or a civil citation associated with the host vehicle and/or the driver of the host vehicle.

Still referring now to FIGS. 1-3, 4A-4C, 5, and 6A-6C, the present disclosure also describes a non-transitory computer readable storage medium having stored computer executable instructions for providing information relating to a remote vehicle (e.g., stopped vehicle 52) and/or a driver of the remote vehicle to an occupant of a host vehicle (e.g., law enforcement vehicle 50) comprising an interface 20 and a controller 18 in communication with the interface. The computer executable instructions may be configured to cause the controller 18 to transmit via a vehicle-to-x (V2X) communication module (e.g., OBU 16 and/or module 12) on-board the host vehicle a request message to the remote vehicle, the request message comprising a request for information relating to the remote vehicle and/or the driver of the remote vehicle, receive via the V2X communication module a response message comprising information relating to the remote vehicle and/or the driver of the remote vehicle, and provide via the interface the information of the response message to the occupant of the host vehicle. Once again, it is noted that any other type of wireless communication technology (including any other type of wireless communication modules, wireless transmissions, signals, or messages) may be utilized in the system and method of the present disclosure rather than vehicle-to-x (V2X) communication technology.

In that regard, the host vehicle may be a law enforcement vehicle and the occupant may be a law enforcement officer. The computer executable instructions may be further configured to cause the controller to transmit the request message via the V2X communication module in response to a command received via the interface from the occupant, and the information of the request message or the response message may comprise registration information relating to the remote vehicle, insurance information relating to the remote vehicle, and/or driver's license information relating to the driver of the remote vehicle. The interface 18 may comprise a human machine interface or a personal computer system, and each of the request message and the response message may comprise a vehicle-to-vehicle (V2V) message.

The computer executable instructions may be further configured to cause the controller to retrieve the information of the response message from a storage device 22 on-board the remote vehicle. The computer executable instructions may also be further configured to cause the controller to transmit via the V2X communication module an information message to the remote vehicle and/or a remote database, the information message comprising information relating to a civil infraction or a civil citation associated with the remote vehicle and/or the driver of the remote vehicle.

Referring still to FIGS. 1-3, 4A-4C, 5, and 6A-6C, the present disclosure also describes a non-transitory computer readable storage medium having stored computer executable instructions for providing information relating to a host vehicle (e.g., stopped vehicle 52) and/or a driver of the host vehicle to an occupant of a remote vehicle (e.g., law enforcement vehicle 50), the host vehicle having on-board an interface and a controller in communication with the interface. The computer executable instructions may be configured to cause the controller to receive via a communication module a wireless request message from the remote vehicle, the request message comprising a request for information relating to the host vehicle and/or the driver of the host vehicle, prompt the driver of the host vehicle via the interface for an authorization to provide information relating to the host vehicle and/or the driver of the host vehicle to the remote vehicle in response to the request message received from the remote vehicle, and in response to receiving via the interface the authorization from the driver of the host vehicle, transmit via the communication module a wireless response message comprising information relating to the host vehicle and/or the driver of the host vehicle.

In that regard, the remote vehicle may be a law enforcement vehicle and the occupant of the remote vehicle may be a law enforcement officer, and the communication module may comprise a vehicle-to-x (V2X) communication module. The information of the request message or the response message may comprise registration information relating to the host vehicle, insurance information relating to the host vehicle, and/or driver's license information relating to the driver of the host vehicle. The interface and controller may be part of a mobile device, or the interface may comprise a human machine interface configured to be mounted in the host vehicle and the controller may be configured to be mounted in the host vehicle. Each of the request message and the response message may comprise a vehicle-to-vehicle (V2V) message.

The host vehicle may further include on-board an audio system and/or a video system to provide telecommunication between the driver of the host vehicle and the occupant of the remote vehicle. Moreover, the information of the response message may be retrieved from a storage device on-board the host vehicle. The computer executable instructions may also be configured to receive via the communication module an information message from the remote vehicle, the information message comprising information relating to a civil infraction or a civil citation associated with the host vehicle and/or the driver of the host vehicle.

In that regard, the computer executable instructions described herein may be stored in or on a computer readable storage medium which may comprise any known type of storage medium or device and may be part of or associated with a controller 18 on-board a vehicle 10, 50, 52 (whether part of the vehicle 10, 50, 52 (e.g., storage medium or device 22) or part of a mobile device configured or configurable for communication with the vehicle 10, 50, 52) or may be located remotely from a vehicle 10, 50, 52 and accessed, accessible, downloaded, or downloadable by or to a controller 18 on-board a vehicle 10, 50, 52 from a remote server or database via any known type of communication network and/or links, which may be wired or wireless.

Accordingly, the system and method of the present disclosure provide a technical solution, such as by utilizing V2X communication technology as described herein, to the technical problem of the absence of any system, method, technique, means, or otherwise to enable, allow, or permit activities associated with a traffic stop of a private vehicle by a law enforcement vehicle to be conducted without requiring or with reduced direct interaction between the private individual(s) and law enforcement official(s) involved. The technical solution of the system and method of the present disclosure to that technical problem thus enables, allows, or permits activities associated with a traffic stop to be conducted in a remote, virtual, or contactless fashion, thereby providing the technical benefit of reduced risk and increased safety for all. The technical solution of the system and method of the present disclosure to that technical problem thus provides the technical benefit of increased, improved, and/or ensured safe interpersonal interactions between private individuals and law enforcement officials during a traffic stop, one of the most common situations giving rise to such interactions, and thereby addresses, mitigates, reduces, and/or eliminates the issues and/or problems associated with traffic stops as described herein.

As is readily apparent from the foregoing, various non-limiting exemplary embodiments of a system and method for providing information relating to a vehicle and/or a driver of a vehicle to an occupant of another vehicle, such as by utilizing V2X communication technology, have been described. While various embodiments have been illustrated and described herein, they are non-limiting and exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A system for providing information relating to a remote vehicle and/or a driver of the remote vehicle to an occupant of a host vehicle, the system comprising:
an interface configured to be mounted in the host vehicle; and
a controller configured to be mounted in the host vehicle and provided in communication with the interface,
wherein the controller is configured to transmit via a communication module on-board the host vehicle a wireless request message to the remote vehicle, the request message comprising a request for information relating to the remote vehicle and/or the driver of the remote vehicle,
wherein the controller is configured to receive via the communication module a wireless response message comprising information relating to the remote vehicle and/or the driver of the remote vehicle, and
wherein the controller is configured to provide via the interface the information of the response message to the occupant of the host vehicle.

2. The system of claim 1 wherein the communication module is a vehicle-to-x (V2X) communication module.

3. The system of claim 2 wherein the host vehicle is a law enforcement vehicle, the occupant is a law enforcement officer, the controller is configured to transmit the request message via the V2X communication module in response to a command received via the interface from the occupant, and the information of the request message or the response message comprises registration information relating to the remote vehicle, insurance information relating to the remote vehicle, and/or driver's license information relating to the driver of the remote vehicle.

4. The system of claim 2 wherein the interface comprises a human machine interface or a personal computer system.

5. The system of claim 2 wherein each of the request message and the response message comprises a vehicle-to-vehicle (V2V) message.

6. The system of claim 2 further comprising an audio system and/or a video system to provide telecommunication between the occupant of the host vehicle and the driver of the remote vehicle.

7. The system of claim 2 wherein the information of the response message is retrieved from a storage device on-board the remote vehicle.

8. The system of claim 3 wherein the controller is configured to transmit via the V2X communication module an information message to the remote vehicle and/or a remote database, the information message comprising information relating to a civil infraction or a civil citation associated with the remote vehicle and/or the driver of the remote vehicle.

9. A system for providing information relating to a host vehicle and/or a driver of the host vehicle to an occupant of a remote vehicle, the system comprising:
an interface for use on-board the host vehicle; and
a controller for use on-board the host vehicle, the controller to be provided in communication with the interface,
wherein the controller is configured to receive via a communication module a wireless request message from the remote vehicle, the request message comprising a request for information relating to the host vehicle and/or the driver of the host vehicle,
wherein, in response to a command received from the controller, the interface is configured to prompt the driver of the host vehicle for an authorization to provide information relating to the host vehicle and/or the driver of the host vehicle to the remote vehicle in response to the request message received from the remote vehicle, and
wherein, in response to receiving via the interface the authorization from the driver of the host vehicle, the controller is configured to transmit via the communication module a wireless response message comprising information relating to the host vehicle and/or the driver of the host vehicle.

10. The system of claim 9 wherein the communication module is a vehicle-to-x (V2X) communication module.

11. The system of claim 10 wherein the remote vehicle is a law enforcement vehicle, the occupant is a law enforcement officer, and the information of the request message or the response message comprises registration information relating to the host vehicle, insurance information relating to the host vehicle, and/or driver's license information relating to the driver of the host vehicle.

12. The system of claim 10 wherein the interface and controller are part of a mobile device, or wherein the interface comprises a human machine interface configured to be mounted in the host vehicle and the controller is configured to be mounted in the host vehicle.

13. The system of claim 10 wherein each of the request message and the response message comprises a vehicle-to-vehicle (V2V) message.

14. The system of claim 10 further comprising an audio system and/or a video system to provide telecommunication between the driver of the host vehicle and the occupant of the remote vehicle.

15. The system of claim 10 wherein the information of the response message is retrieved from a storage device on-board the host vehicle.

16. The system of claim 11 wherein the controller is configured to receive via the V2X communication module an information message from the remote vehicle, the information message comprising information relating to a civil infraction or a civil citation associated with the host vehicle and/or the driver of the host vehicle.

17. A non-transitory computer readable storage medium having stored computer executable instructions for providing information relating to a remote vehicle and/or a driver of the remote vehicle to an occupant of a host vehicle comprising an interface and a controller in communication with the interface, the computer executable instructions configured to cause the controller to:
transmit via a communication module on-board the host vehicle a wireless request message to the remote vehicle, the request message comprising a request for information relating to the remote vehicle and/or the driver of the remote vehicle;
receive via the communication module a wireless response message comprising information relating to the remote vehicle and/or the driver of the remote vehicle; and
provide via the interface the information of the response message to the occupant of the host vehicle.

18. The non-transitory computer readable storage medium of claim 17 wherein the host vehicle is a law enforcement vehicle, the occupant is a law enforcement officer, the communication module is a vehicle-to-x (V2X) communication module, the computer executable instructions are further configured to cause the controller to transmit the request message via the V2X communication module in response to a command received via the interface from the occupant, and the information of the request message or the response message comprises registration information relating to the remote vehicle, insurance information relating to the remote vehicle, and/or driver's license information relating to the driver of the remote vehicle.

19. The non-transitory computer readable storage medium of claim 17 wherein the computer executable instructions are further configured to cause the controller to retrieve the information of the response message from a storage device on-board the remote vehicle.

20. The non-transitory computer readable storage medium of claim 18 wherein the computer executable instructions are further configured to cause the controller to transmit via the V2X communication module an information message to the remote vehicle and/or a remote database, the information message comprising information relating to a civil infraction or a civil citation associated with the remote vehicle and/or the driver of the remote vehicle.
